(19) United States
(12) Patent Application Publication
(10) Pub. No.: US 2022/0391928 A1
(43) Pub. Date: Dec. 8, 2022

(54) SYSTEM AND METHOD FOR ANALYSING CUSTOMER EXPERIENCE FROM UNSTRUCTURED SOCIAL MEDIA DATA

(71) Applicant: Infosys Limited, Bangalore (IN)

(72) Inventors: Debamalya Choudhury, Bangalore (IN); Vinay Govindan Muralidharan, Bangalore (IN); Kanad Bhowmik, Bangalore (IN); Romi Malik, Bangalore (IN); Rashmikant Mohanty, Bangalore (IN)

(21) Appl. No.: 17/517,073

(22) Filed: Nov. 2, 2021

(30) Foreign Application Priority Data
Jun. 2, 2021 (IN) 202141024501

(51) Int. Cl. G06Q 30/02; G06Q 50/00; G06F 16/9532

(52) U.S. Cl. CPC G06Q 30/0201; G06Q 50/01; G06F 16/9532

(57) ABSTRACT

A method and system for analyzing customer experience from unstructured social media data comprising, fetching data from the social media platforms and segregate these social media conversations into campaign data, a “True social” data, and news data using the industry topic related keywords. Furthermore, it also identifies from the true social data, different stages of customer experience such as a pre-experience data, a during-experience data and a post-experience data. It enables identification of at risk customers, loyal customers, and one or more target customer of a brand. Customer issue areas may also be identified that a brand needs to focus on along with identification of key social media influencers who are influencing conversations for or against brand and enables the brand to take appropriate action based on the analysis of various posts.

This application claims the benefit of Indian Patent Application Serial No. 202141024501 filed Jun. 2, 2021, which is hereby incorporated by reference in its entirety.

### FIELD

This technology generally relates to data analysis, more particularly, to methods for analyzing customer experience of a brand, from unstructured social media data.

### BACKGROUND

Users and customers are now very actively using social media to interact with brands. They can put their concerns, feedbacks, complaints and share their experiences. Social media also influences the online campaigns launched and run by the brands. With the wide usage of social media and a change of stance towards it by the various brands, it is generating huge volumes of posts due to an increase in the number of tweets aimed at brands and a brand's response, campaign posts and of course amplification of news posts and personal posts. However the present technologies have a very limited analysis capability offering without any scope of deep dive analysis to pin point a trouble in customer experience.

### SUMMARY

A method for analyzing customer experience from unstructured social media data, comprising of creating industry topic related keywords, an experience phase topic related keywords, a “at-risk” topic related keywords and a loyalty topic related keywords; retrieving data from the social media platform, relating to one or more brands; categorizing the retrieved data into one of campaign data, a “True social” data, and news data using the industry topic related keywords; creating a chronological user conversation and a chronological brand conversation group using the categorized True social data; identifying a pre-experience data, an during-experience data and a post-experience data from the categorized True social data using the experience phase related keywords; identifying query data, and complaint data from the identified pre-experience data, the during-experience data and the post-experience data; identifying one or more loyal customers, one or more “at-risk” customers and one or more target customer using the identified query data, the identified complaint data, the loyalty topic related keywords and the “at-risk” topic related keywords; and providing a prepared report using the identified one or more loyal customers, the one or more at-risk customers, one or more target customer, the query data, and the complaint data.

A system for analyzing customer experience from unstructured social media data, comprising, a communication interface; a memory, wherein the memory stores instructions; and a processor, configured to creating industry topic related keywords, an experience phase topic related keywords, a at-risk topic related keywords and a loyalty topic related keywords; retrieving data from the social media platform, relating to the one or more brands; categorizing the retrieved data into one of campaign data, True social data, and news data using the industry topic related keywords; creating a chronological user conversation and a chronological brand conversation group using the categorized True social data; identifying a pre-experience data, an during-experience data and a post-experience data from the categorized True social data using the experience phase related keywords; identifying query data, and complaint data from the identified pre-experience data, the during-experience data and the post-experience data; identifying one or more loyal customers, one or more risk customers and one or more target customer using the identified query data, the identified complaint data, the loyalty topic related keywords and the risk topic related keywords; and providing a prepared report using the identified one or more loyal customers, the one or more At-risk customers, the one or more target customer, the query data, and the complaint data.

A non-transitory, computer-readable storage medium storing instructions executable by a processor of a computational device for analyzing customer experience from unstructured social media data which when executed cause the computational device to create industry topic related keywords, experience topic related keywords, risk topic related keywords and loyalty topic related keywords; retrieve data from the social media, relating to the one or more brands; categorize the retrieved data into one of campaign data, True social data, and news data using the industry topic related keywords; create a chronological user conversation and a chronological brand conversation group using the categorized True social data; identify a pre-experience data, an during-experience data and a post-experience data from the categorized True social data using the experience phase related keywords; identify query data, and complaint data from the identified pre-experience data, the during-experience data and the post-experience data; identify one or more loyal customers, one or more at-risk customers and one or more target customer using the identified query data, the identified complaint data, the loyalty topic related keywords and the at-risk topic related keywords; and prepare a report using the identified one or more loyal customers, the one or more at-risk customers, the one or more target customer, the query data, and the complaint data.

This technology provides several advantages including providing more effective methods, non-transitory computer readable medium and system for analyzing posts related to a brand on a social media platform and identifying corrective actions to improve the value of the brand. Additionally, with this technology, at-risk customers, loyal customers and other categorizing of customers and posts can be done and identified.

### BRIEF DESCRIPTION OF THE DRAWINGS

FIG. 1 is an exemplary network environment which comprises a system for analyzing posts related to a brand on a social media platform;

FIG. 2 is a flowchart of an exemplary method for analyzing posts;

FIG. 3 is a high-level illustration of an exemplary computing system for analyzing posts;

FIG. 4 is an illustration of an exemplary data set; and

FIG. 5 is an exemplary data flow illustration for the system for analyzing posts.

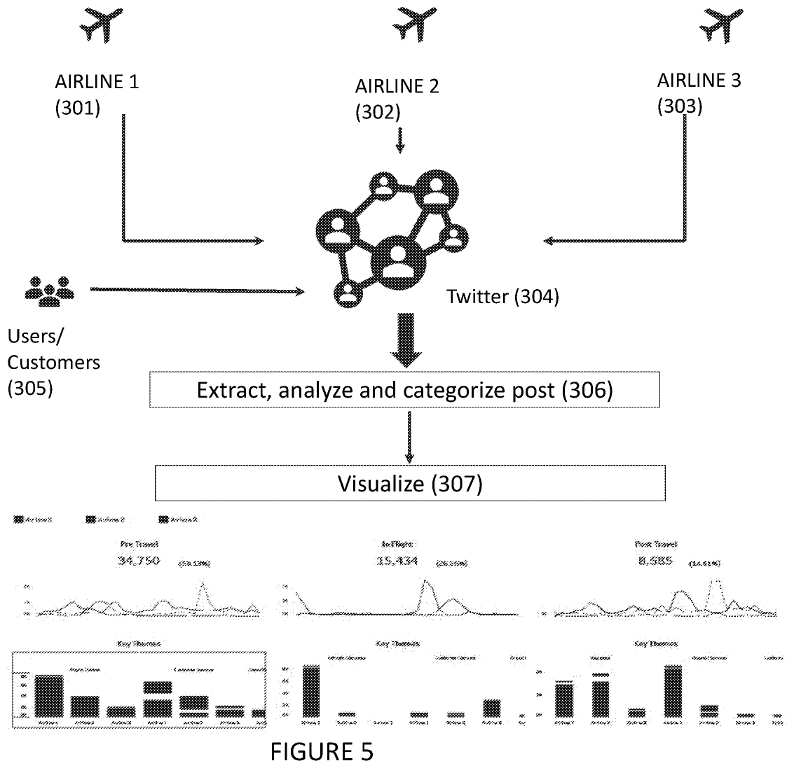

### DETAILED DESCRIPTION

While the particular embodiments described herein may illustrate the disclosure in a particular domain, the broad principles behind these embodiments could be applied in other fields of endeavor. To facilitate a clear understanding of the present disclosure, illustrative examples are provided herein which describe certain aspects of the disclosure. However, it is to be appreciated that these illustrations are not meant to limit the scope of the disclosure and are provided herein to illustrate certain concepts associated with the disclosure.

It is also to be understood that the present disclosure may be implemented in various forms of hardware, software, firmware, special purpose processors, or a combination thereof. Preferably, the present disclosure is implemented in software as a program tangibly embodied on a program storage device. The technology may be uploaded to, and executed by, a machine comprising any suitable architecture.

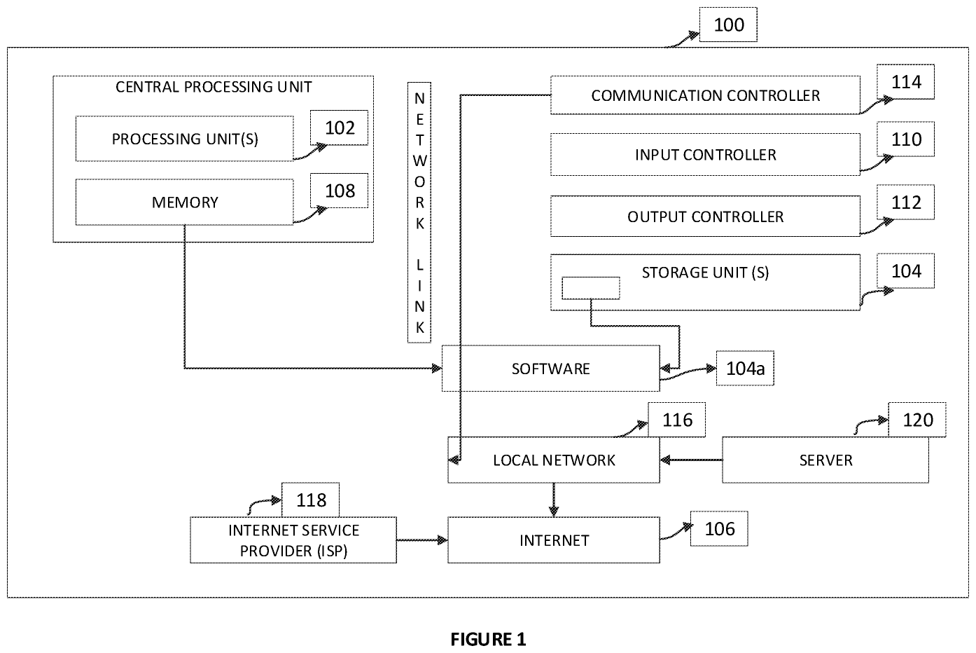

FIG. 1 (PRIOR-ART) is a block diagram of a computing device 100 to which the present disclosure may be applied according to an embodiment of the present disclosure. The computing machine may be configured for performing the process of predictive maintenance of a machine as explained herewith. The computing device and the machine may connected together by the Local Area Network (LAN) and Wide Area Network (WAN) including other types and numbers of devices, components, elements and communication networks in other topologies and deployments. While not shown, additional components, such as routers, switches and other devices which are well known to those of ordinary skill in the art may also be used and thus will not be described here. This technology provides several advantages including providing more effective methods, non-transitory computer readable medium and devices for predictive maintenance. The system includes at least one processor 102, designed to process instructions, for example computer readable instructions (i.e., code) stored on a storage device 104. By processing instructions, processing device 102 may perform the steps and functions disclosed herein. Storage device 104 may be any type of storage device, for example, but not be limited to, an optical storage device, a magnetic storage device, a solid-state storage device and a non-transitory storage device. The storage device 104 may contain software 104a which is a set of instructions (i.e. code). Alternatively, instructions may be stored in one or more remote storage devices, for example storage devices accessed over a network or the internet 106. The computing device also includes an operating system and microinstruction code. The various processes and functions described herein may either be part of the microinstruction code or part of the program (or combination thereof) which is executed via the operating system. Computing device 100 additionally may have memory 108, an input controller 110, and an output controller 112 and communication controller 114. A bus (not shown) may operatively couple components of computing device 100, including processor 102, memory 108, storage device 104, input controller 110 output controller 112, and any other devices (e.g., network controllers, sound controllers, etc.). Output controller 110 may be operatively coupled (e.g., via a wired or wireless connection) to a display device (e.g., a monitor, television, mobile device screen, touch-display, etc.) in such a fashion that output controller 110 can transform the display on display device (e.g., in response to modules executed). Input controller 108 may be operatively coupled (e.g., via a wired or wireless connection) to input device (e.g., mouse, keyboard, touch-pad, scroll-ball, touch-display, etc.) in such a fashion that input can be received from a user. The communication controller 114 is coupled to a bus (not shown) and provides a two-way coupling through a network link to the internet 106 that is connected to a local network 116 and operated by an internet service provider (hereinafter referred to as ‘ISP’) 118 which provides data communication services to the internet. Network link typically provides data communication through one or more networks to other data devices. For example, network link may provide a connection through local network 116 to a host computer, to data equipment operated by an ISP 118. A server 120 may transmit a requested code for an application through internet 106, ISP 118, local network 116 and communication controller 114. Of course, FIG. 1 illustrates computing device 100 with all components as separate devices for ease of identification only. Each of the components may be separate devices (e.g., a personal computer connected by wires to a monitor and mouse), may be integrated in a single device (e.g., a mobile device with a touch-display, such as a smartphone or a tablet), or any combination of devices (e.g., a computing device operatively coupled to a touch-screen display device, a plurality of computing devices attached to a single display device and input device, etc.). Computing device 100 may be one or more servers, for example a farm of networked servers, a clustered server environment, or a cloud network of computing devices.

Although an exemplary computing environment is described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

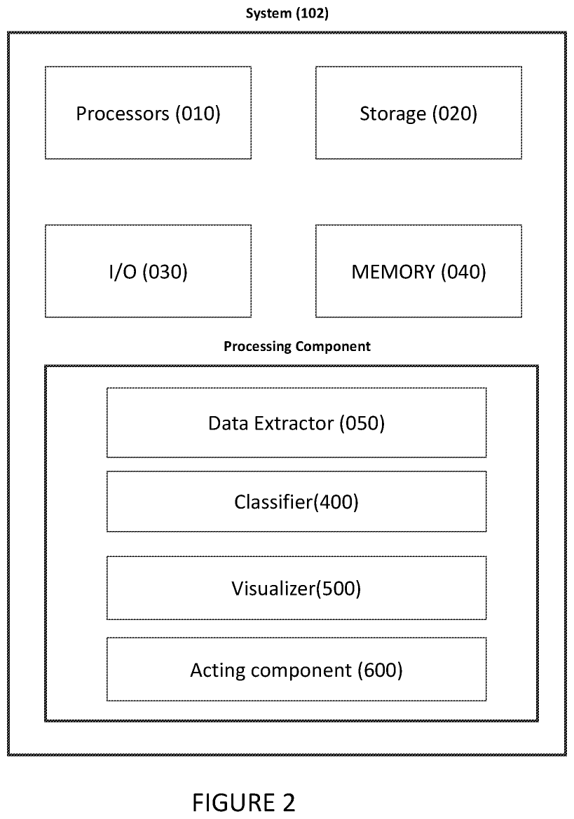

FIG. 2 is a flowchart of an exemplary method for analyzing posts related to a brand or a company on any social media platform. The following are listed for the purpose of this application and facilitate the understanding.

An author may be a social media platform user who has posted some content from a social media platform handle. This handle can be a personal user's handle, or a brand's handle.

An influencer is a social media platform user who has been identified as having an ability to increase or affect the reach of a content positively or negatively based on the factors considered (205).

True Social data or conversation is defined as conversations that are directed towards the brand(s) or are from the brand themselves around the product and services that they are providing.

The social media platform (200) produce a huge amount of unstructured data (200), relating to various brands and their interaction with customers. Each of these conversations provide a row level record at a conversation level. Most of this conversation data is publicly available for consumption.

An embodiment of the present disclosure may include extraction of the data (201) pertaining to a brand and its one or more competitors from a social media platform. In an embodiment it can be multiple social media platforms. In one embodiment, the brand may select the competitors for which it wants to extract the data from the social media platform. This data may be extracted directly from the social media platforms by using standard and engagement APIs (202). In another embodiment any appropriate social media listening tools may be used. The extracted data may be converted into a suitable format thereby sending the data to a social content database (203). The extracted data may relate to only the brand also.

In one embodiment, the social content database may store the extracted data in a table within the database. The table is referenced hereafter as raw data (203.1). The raw data may comprise relevant fields that would be utilized further in the respective methods. The field may comprise, but not be limited to, Article Id, External Author Id, Author, Retweet, Content, Username Mentioned, Published Date which hereby will be reference as relevant columns in the paragraphs below. In one embodiment, the field “Author” may contain handles of customers or users who have posted for the brand or any of its competitors and the field also contains handle of the brand which it uses to either respond on in general post of the platform. These author handles are the brand or brand handle and user handle which will help in identifying a conversation of a user with the brand. It will also help in identifying the brand's reply to a user. The conversation of a user with a competitor brand may also be identified.

In one embodiment, the present technology may create a predefined set of one or more profiles (208). In one embodiment, four profiles may be created—industry profile, an experience phase profile, a risk profile and a loyalty profile. Profiles may be created by identifying a set of related keywords. In one embodiment, machine learning algorithms can be used to create the profiles. In an embodiment, there may be overlap of keywords configured for each profile. These keywords may be configured and stored to be accessed and referred by the system as and when required while analyzing the posts.

In an embodiment, industry topic profile may represent keywords which may be associated with a brand's or a competitor's general posts for the users, or for some campaigns and other similar related posts. Some such keywords may be related to the product names, product types. In case of airline brand the keywords may be “baggage”, “reschedule”, “delayed”, “boarding” etc. This profile may help identify posts related to the brand.

In an embodiment, an experience phase profile may represent keywords which may be associated with a user's experiences. For the purpose of explanation, if it's a hotel related brand keywords may relate to booking experience related, stay related, or checkout related. Depending on the brand, the keywords may be configured to be related to pre experience phase, during-experience phase and post experience phase. Some such keywords may be—‘bookings’, comfortable experience, delays etc.

Pre experience phase of the experience phase profile may relate to a user's actions and activity that may be needed before actually using the products. In case of an airline brand the pre experience phase may include selecting flights, seats, booking tickets and refreshments etc.

During-experience phase of the experience phase profile may relate to a user's actions and activity that may be needed while using the products. In case of an airline brand the during-experience keywords may include check in procedures, baggage handling, cabin experience, flight timings etc.

Post experience phase of the experience phase profile may relate to a user's actions and activity that may be needed after the actual use by a user. In case of an airline brand the post experience keywords may relate to lost baggage, delayed landings etc.

In an embodiment, an at-risk profile may represent keywords associated with complaints, negative experiences and similar related topics. This may help identify posts by an unhappy customer, and accordingly a brand can identify if it may lose a regular or old customer. Some keywords may be ‘never use again’, ‘last experience’, one of the worst etc.

In an embodiment, loyalty profile may represent keywords associated with happy, and old customers, or customers giving positive feedback, and other such topics. This will help the brand identify loyal customers from various user handles. Some keywords may be (e.g.). ‘as always, I will be selecting this choice’, ‘loyalty programs’.

The above listed profiles and the related keywords may be user configurable and can be modified as per the requirements of the brand, the industry, the end user type and other such factors. In an embodiment, the products associated with a brand may also include services.

In an embodiment once the profiles are created, the extracted data may be analyzed to identify campaign data (209). This may be done using industry topic profile on the extracted data. Campaign data may be identified by selecting posts which are created from the brand handle. The author of such posts may be the brand or the competitor handle. Alternatively, the posts may not be starting with @______. This may be done to avoid posts targeting a specific user. Similarly, users can configure rule as per their industry to identify and categorize campaign related posts from a social media platform. Campaign data may be posts related to any event or advertising or similar posts. This may include some contest related posts also.

In one embodiment, the extracted may be analyzed to identify True social data (210). True Social data may be general queries data from user. It may include feedback data, some request related, or complains from a user. It can be identified as user driven True social data and brand driven True social data. The extracted data can be categorized into user True social data and brand or competitor True social data, using industry topic profile. Some of the rules that may be applied for this categorization may be user True social data may not have the brand or its competitor as the author. The keywords may be from the industry topic profile. The brand driven True social data may not have user as the author, and keywords may be from the industry topic profile. Similarly users can configure rule as per their industry to identify and categorize.

In an embodiment, the True social data may be arranged chronologically to identify a single conversation. Other rules may be applied to identify a single conversation. One rule may be that it should not be a repeat or a forwarded post. This may be done by considering the value of a post which indicates if it's an original post or a forwarded post.

In one embodiment, the posts or extracted data which are not categorized as True social data or campaign data or remains after all the categorization is done may be categorized as News data (211). This data or posts may be those which do not satisfy the rules for campaign data or True social data.

The present disclosure may use semantic analysis and natural language processing for the analysis and speech recognition required for the implementation of the process as disclosed above. The concept disclosed herein may also be implemented by any other speech, text and language analysis related technology.

The True social data categorized as explained above is further analyzed using industry topic profiled keywords, to categorize it into experience phase data (212), loyal customer data (213), target customer data (214) and at-risk customer data (215). True Social data may also be analyzed under two categories i.e. user initiated social posts and brand, or competitor initiated social posts.

In an embodiment, three experience phases can be identified, i.e. pre experience, during-experience and post experience. For purpose of explanation an example can be—in case of an apparel brand—‘before experience’ can be finding a showroom, or the online app; ‘during-experience’ may be the experience of a user while in the showroom, the availability of products and the behavior of the staff etc.; and ‘post experience’ may be in case of return, or for any installations etc. Posts related to such topics can be accordingly classified.

Experience phase data may also be chronologically categorized into a conversation and identify user queries the corresponding responses.

In one embodiment, loyal customer may be identified by analyzing posts and conversations and perform a search of loyalty points related posts, member ship related posts and other such related parameters (213). Once such posts are identified, they may be categorized into a conversation by checking chronology and user query-response mapping.

In one embodiment, user may configure other appropriate rules to identify the loyal customers, from the social media posts.

In one embodiment, at-risk customers can be identified by analyzing posts and conversations and perform a search of at-risk related topics in the extracted data (215) of the brand. Such topics can be an aggrieved customer post, who may have got a bad quality service or products and other such related parameters. Once such posts are identified, they may be categorized into a conversation by checking chronology and user query-response mapping.

In one embodiment, user may configure other appropriate rules to identify the at-risk customers from the social media posts.

In an embodiment, target customers may also be identified from the extracted data of the brand or the competitor. As an example if one user is posting in a social media platform that , “I heard that Spice jet airline has good service”, or posting “This time I want to fly Spice Jet airlines”, then this user may become a target or lead for Spice Jet”. Alternately as an example the at-risk customers of one brand may be a target customer for other brand. Other configurable options may be used to identify target customers as per the industry. For purpose of explanation, if a customer says “I will never fly Indigo airlines”, then this customer becomes a lead or a target for Spice Jet airlines and vice versa.

In one embodiment, the campaign category, social category, and news category data may be further analyzed along with experience phase, risk customer, loyal customer and target customers categories. These data may be analyzed to get the sentiment of the posts. The data campaign category and the social category data may be again analyzed to identify the influencer customer. Influencer customer may be defined as a user with maximum followers, a user whose posts are responded or forwarded in least time or less than a prescribed time, and the frequency of post forwarding may also be compared to a threshold value. There may be other parameters that may be included for identifying influencer customer.

In an embodiment, identifying these influencers may help in prioritizing response, content modification and mitigation of negative virality. It may help a brand prioritize while responding to its users based on who is a strong influencer. For campaign it may help in targeted social media ads and engagement, by identifying bigger influencer posting positively about the industry.

Once the extracted data is analyzed and categorized into campaign data, True social data, news data, and other identified data and analysis explained above, these may be stored within the social content database (203) as a curated data (203.2). All the above explained analysis, identification and categorization may be implemented by a Classification Component (204), which is configured to review and perform the process.

The curated data is then transferred to a visualization component (216). Any visualization or Business Intelligence tool or visualization may be used to generate and showcase a competitive dashboard with the present brand versus a competitor's brand (219). The present implementation may be tool agnostic. An independent dashboard may also be created, which showcases the various posts related to the brand. These may not include a comparison with a competitor. The dashboard may be formed using many parameters from the various identifications, categorization explained above. A user can select appropriate KPIs, and metrics (217). The dashboard may be used for analyzing the Experience Phase (220), Campaign analysis (221), News analysis (222) and Influencers (218).

The brand may review the dashboard, the KPIs used and accordingly check the performance, market reviews and user sentiments for it. This may help the brand improve the experience of customers, and identify areas of improvement e.g. better campaigns, smooth user experiences, better rates and products etc.

This data may be sent to the Action Rule Engine (225) which may check the output provided by the analysis and send the recommended action to a trigger action system (226). The curated data may be checked for negative tonality based conversation and additionally rules may be applied in the action rules engine, with consideration of different flags related to Loyalty, at Risk and Potential customer. The authors may be flagged for priority and severity of the need or problem and this information can be passed on to the response system which may comprise any, but not be limited to, applications like email system, CRM for few to be named. The response system may then be based on the business process and policies, address the customers accordingly.

In an embodiment the process as disclosed may facilitate the brand to increase the goodwill. A brand's goodwill is equally important asset as its capital. Implementing the above described process, a brand can improve the valuation using the goodwill. The change in valuation can be formulated in digitized form and can be presented statistically and graphically as well. The analysis explained above may be implemented in a user configured manner to achieve a desired valuation improvement. Such implementation may be user configurable.

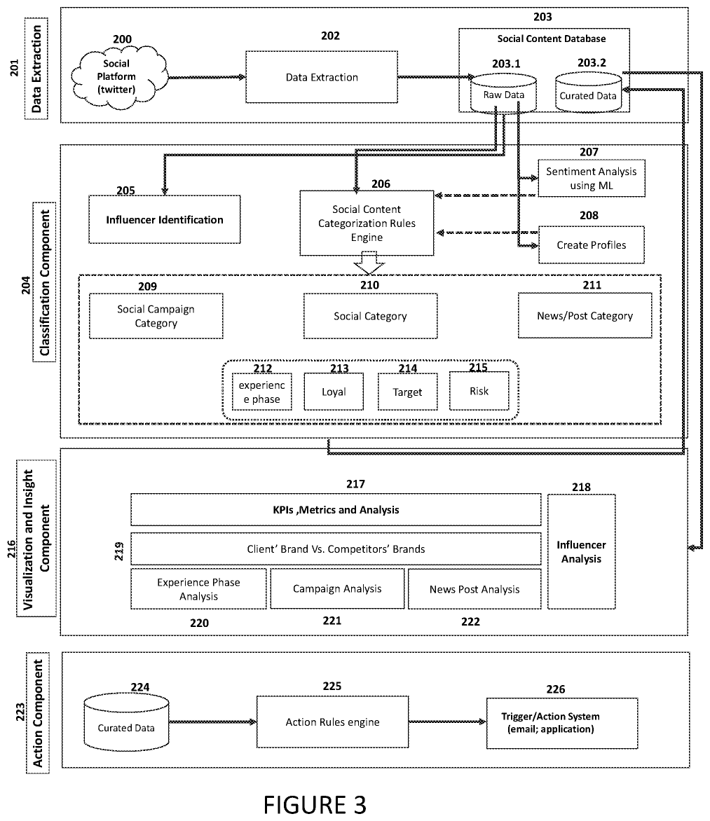

FIG. 3 explains a high-level illustration of an exemplary computing system (102) for analyzing posts using the process as described above. A general purpose computing machine, or any computing or communication device can be used for implementing the present disclosure. These devices may be connected to the network for accessing a required social media platform and process the data. In an embodiment the computing machine may comprise of components including processor (010), Input-Output enablers (030), Storage and Memory components (020, 040).

These components may enable the computing system to implement and process the data. They may have instructions stored therein configured to perform the described process. Storage component (020) may contains temporary database for social media content. These contents posts may be purged periodically as per users requirements.

In an embodiment, there may be one or more processing components, further comprising a data extractor (050). Data extractor may comprise of web crawlers and other similar and related technical features and enablers to identify one or more required social media platform, identify the authors, and extract the required data. This data may be transferred by the extractor to a database in the storage.

In an embodiment, a classifier (400) fetches the data from the storage and performs the identification and classification as explained along with the description of FIG. 2. A classifier may be appropriately configured by the user to identify and classify the extracted data, according to the requirements of a brand.

The analyzed and classified data may be sent to the Visualizer (500). It may also be configured to generate an insight on the customer experiences, complains, risk customers and others as explained above. The visualizer may have dashboard generating sub components linked to, or instructions configured to generate a dashboard based on KPIs and parameters as needed by the brands, or as available from the categorized data.

The brands may decide to take appropriate corrective actions for customers based on the dashboards. The dashboards are accessed by Acting component (600) which may be configured to help out or notify the brand's designated person/s, concerned users or sections in the brands to take a required action as required. The notification can be mail based, or any other appropriate form. The acting component may also be configured to trigger corrective actions.

In an embodiment, the disclosed system may be implemented on a local machine, at the brand's computing environment, or they may be client machines. It may be linked using networking means to one or more social media servers. The client machine may search and request data from social media servers. The fetched data may be processed at the brand's client machine, local machine. The implementation may be done using one or more client machines and one or more server machines. The present system may be implemented on cloud and can be provided to users as SAAS exposing the model as api and as batch.

These components are an exemplary architecture to implement the concept and process as disclosed in this document. Any other component can be used in the computing system, in place of the ones described herewith. These are not meant to limit the scope of the disclosure, and are provided herein to only illustrate certain concepts associated with the disclosure.

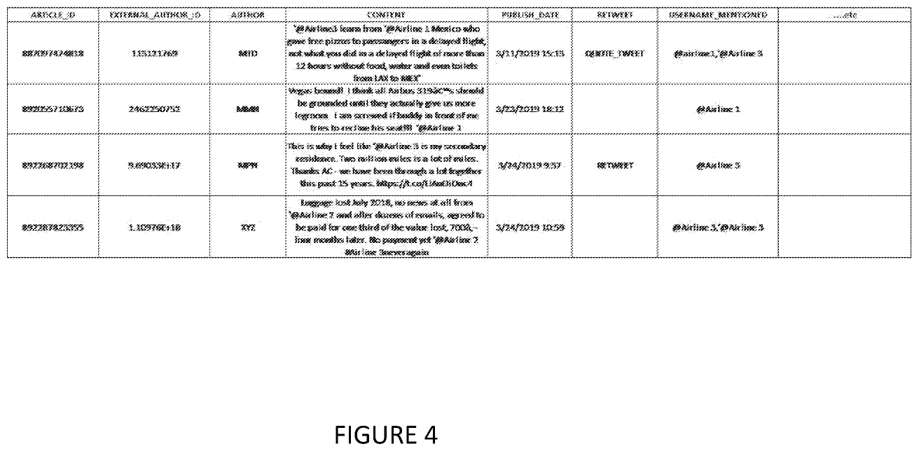

FIG. 4 provides an exemplary dataset that may be implemented for the present disclosure.

In an embodiment, the extracted data may be stored in the table as shown in this Fig. Article Id may refer to a unique identifier given to each post. Some users may also use an author identifier, along with name of the author. This section may identify the author as a customer or the brand, or some other competitor etc.

The data set may store the main content of the post, along with the metadata. Once the process of identifications, sentiment analysis and other related processes get implemented the data set is accordingly updated with more tables, and more fields and columns.

The implementation and the utility can be understood from an exemplary implementation of this disclosure in airline industry. For the purpose of explanation, let us consider an airline brand (301) that implements the present disclosure. Once an airline brand initiates using this system, it first uses machine learning to create profiles. The machine learning trains the model and creates multiple profiles. For this example, we may use Twitter (304) as the social media platform being used. We also consider the tweets from competitor airline brands (301, 302).

The system will help the airlines to segregate the huge amount of Twitter data into three categories of conversations (306)—the “Social” conversations, includes the conversations of a customer with the airline regarding various issues faced by the customer. The “Campaign” conversations are the conversations pertaining to the different organic Twitter campaigns run by the airlines and “News and Posts” conversations are the conversations on various news articles and personal posts.

This system will enable the airlines to analyze the key themes and sub themes across different journey stages like “Pre-flight”, “In-flight” and “Post-flight” which helps in diagnosing its customer conversations and interpret the key concerns. It will also enable competitive analysis at the “Key Themes” and “Sub Themes” level for the respective Journey phases.

Loyal Customer, New lead/Potential customer (305) can be identified and at risk customers for an airline can be flagged and identify influencer and indicate their network strength which includes, but not be limited to, topics, engagement, category, time and identify their ability to create and propagate content and help in amplification of conversations in Twitter.

The system also analyzes the campaign conversations of an airline and helps in assessing its social media organic campaign success. During visualization (307) the system enables multi-level filtering and comprises of KPI and metric view of an airline vs. Competitor brands comparison.

This system then enables an airline to receive real time notifications through its action module on when and whom to connect or respond to a specific conversation. It will make the airlines more equipped to manage exigencies by identifying key focus areas upfront from the huge volumes of social media conversations and respond to crucial conversation.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for analyzing customer experience from unstructured social media data comprising,
creating industry topic related keywords, experience topic related keywords, risk topic related keywords and loyalty topic related keywords;
retrieving data from the social media, relating to a one or more brands;
categorizing the retrieved data into one of campaign data, True social data, and news data using the industry topic related keywords;
creating a chronological user conversation and a chronological brand conversation group using the categorized True social data;
identifying pre-experience data, during-experience data and post-experience data from the categorized True social data using the experience phase related keywords;
identifying query data, and complaint data from the identified pre-experience data, the during-experience data and the post-experience data;
identifying one or more loyal customers, one or more risk customers and one or more target customer using the identified query data, the identified complaint data, the loyalty topic related keywords and the risk topic related keywords; and
providing a prepared report using the identified one or more loyal customers, the one or more risk customers, the one or more target customer, the query data, and the complaint data.

2. The method as claimed in claim 1, further comprising a sentiment analysis of the retrieved data for identifying a tonality of the data.

3. The method as claimed in claim 1, wherein the campaign data is identified from a brand tag in the extracted data.

4. The method as claimed in claim 1, wherein the retrieved data not categorized as the campaign data or the True social data, is categorized as news data.

5. The method as claimed in claim 1, wherein the extracted data and the categorized data are stored in a database.

6. The method as claimed in claim 1, further comprising identifying influencers from the extracted data.

7. The method as claimed in claim 6 further comprising recommending appropriate actions on the identified risk customers, the loyalty customers, the target customers and the influencers.

8. The method as claimed in claim 1, wherein preparing reports further comprises selecting one or more parameters and providing the report according to the selected parameters.

9. A system for analyzing customer experience from unstructured social media data comprising,
a communication interface;
a memory, wherein the memory stores instructions; and
a processor, configured to:
creating industry topic related keywords, experience topic related keywords, risk topic related keywords and loyalty topic related keywords;
retrieving data from the social media, relating to a one or more brands;
categorizing the retrieved data into one of campaign data, True social data, and news data using the industry topic related keywords;
creating a chronological user conversation and a chronological brand conversation group using the categorized True social data;
identifying a pre-experience data, a during-experience data and a post-experience data from the categorized True social data using the experience phase related keywords;
identifying query data, and complaint data from the identified pre-experience data, the during-experience data and the post-experience data;
identifying one or more loyal customers, one or more risk customers and one or more target customer using the identified query data, the identified complaint data, the loyalty topic related keywords and the risk topic related keywords; and
providing a prepared report using the identified one or more loyal customers, the one or more risk customers, the one or more target customer, the query data, and the complaint data.

10. The system as claimed in claim 9 wherein the processor is further configured for performing a sentiment analysis of the retrieved data for identifying a tonality of the data.

11. The system as claimed in claim 9, wherein the campaign data is identified from a brand tag in the extracted data.

12. The system as claimed in claim 9, wherein the retrieved data not categorized as the campaign data or the True social data, is categorized as news data.

13. The system as claimed in claim 9, wherein the extracted data and the categorized data are stored in a database.

14. The system as claimed in claim 9, wherein the processor is configured to identify influencers from the extracted data.

15. The system as claimed in claim 14 wherein the processor is configured to recommend appropriate actions on the identified risk customers, the loyalty customers, the target customers and the influencers.

16. The system as claimed in claim 9, wherein the preparing reports further comprises selecting one or more parameters and providing the report according to the selected parameters.

17. A non-transitory, computer-readable storage medium storing instructions executable by a processor of a computational device for analyzing customer experience from unstructured social media data comprising, which when executed cause the computational device to:
create industry topic related keywords, experience topic related keywords, risk topic related keywords and loyalty topic related keywords;
retrieve data from the social media, relating to a one or more brands;
categorize the retrieved data into one of campaign data, True social data, and news data using the industry topic related keywords;
create a chronological user conversation and a chronological brand conversation group using the categorized True social data;
identify a pre-experience data, a during-experience data and a post-experience data from the categorized True social data using the experience phase related keywords;
identify query data, and complaint data from the identified pre-experience data, the during-experience data and the post-experience data;
identify one or more loyal customers, one or more risk customers and one or more target customer using the identified query data, the identified complaint data, the loyalty topic related keywords and the risk topic related keywords; and
prepare a report using the identified one or more loyal customers, the one or more risk customers, the one or more target customer, the query data, and the complaint data.

18. The computer readable storage medium as claimed in claim 17 comprising performing a sentiment analysis of the retrieved data for identifying a tonality of the data.

19. The computer readable storage medium as claimed in claim 17, wherein the campaign data is identified from a brand tag in the extracted data.

20. The computer readable storage medium as claimed in claim 17, wherein the retrieved data not categorized as the campaign data or the True social data, is categorized as news data.

21. The computer readable storage medium as claimed in claim 17, wherein the extracted data and the categorized data are stored in a database.

22. The computer readable storage medium as claimed in claim 17, further comprising identifying influencers from the extracted data.

23. The computer readable storage medium as claimed in claim 22 further comprising recommending appropriate actions on the identified risk customers, the loyalty customers, the target customers and the influencers.

24. The computer readable storage medium as claimed in claim 17, wherein the preparing reports further comprises selecting one or more parameters and providing the report according to the selected parameters.
